(19) United States
(12) Patent Application Publication
(10) Pub. No.: US 2008/0174582 A1
(43) Pub. Date: Jul. 24, 2008

(54) Plasma display device and driving method thereof

(76) Inventor: Sang-Chul Kim, Suwon-si (KR)

Correspondence Address: ROBERT E. BUSHNELL, 1522 K STREET NW, SUITE 300, WASHINGTON, DC, 20005-1202, US

(21) Appl. No.: 11/987,249

(22) Filed: Nov. 28, 2007

(30) Foreign Application Priority Data
Jan. 23, 2007 (KR) 10-2007-0007035

(51) Int. Cl. G06F 3/038

(52) U.S. Cl. 345/208

(57) ABSTRACT

In driving a plasma display device, a driving time is accumulatively calculated, and the number of subfields to which a main reset waveform for initializing every discharge cell is supplied in a first frame in which the accumulative driving time is longer than a reference time is larger than the number of subfields to which the main reset waveform is supplied in a second frame in which the accumulative driving time is shorter than the reference time. By increasing the number of subfields to which the main reset waveform is supplied in a single frame with an increase in the accumulative driving time of the plasma display device, a discharge delay can be reduced by using priming particles formed by a main reset.

### CLAIM OF PRIORITY

This application makes reference to, incorporates the same herein, and claims all benefits accruing under 35 U.S.C. §119 from an application for PLASMA DISPLAY DEVICE AND DRIVING METHOD THEREOF earlier filled in the Korean Intellectual Property Office on 23 Jan. 2007 and there duly assigned Serial No. 10-2007-0007035.

### BACKGROUND OF THE INVENTION

1. Field of the Invention

The present invention relates to a plasma display device and its driving method.

2. Description of the Related Art

The plasma display device is a flat panel display for displaying characters or images by using a plasma generated by a gas discharge, in which hundreds of thousands to millions of discharge cells are arranged in a matrix form according to its size.

In driving the plasma display device, a single frame (1 TV field) is divided into a plurality of subfields each having a weight value, and each field includes a reset period, an address period, and a sustain period in terms of a temporal operations.

The reset period is a period during which a state of each cell is initialized to facilitate an addressing operation in each cell, and the address period is a period during which wall charges are accumulated by supplying an address voltage to cells to be turned on (namely, addressed cells) to thus select cells of a panel which are turned on and cells which are not turned on. The sustain period is a period during which sustain discharge pulses are supplied to actually display an image on the addressed cells.

FIG. 1 is a view of driving waveforms of a related art plasma display device.

As shown in FIG. 1, in the related art plasma display device, a main reset is performed only in a portion (SF1) of the plurality of subfields and an auxiliary reset is performed in the other remaining subfields SF2˜SF8. The main reset refers to a reset period during which every discharge cell is initialized, and the auxiliary reset refers to a reset period during which a cell in which a sustain discharge has occurred in an immediately previous subfield is initialized.

In particular, in the plasma display device, as its driving time accumulatively increases, the characteristics of a magnesium oxide (MgO) layer change to cause a discharge delay to be increased. When the discharge delay occurs during a rising period of the main reset period, a discharge between Y and X electrodes moves from a point of time P1 to a point of time P2. A voltage difference between the X and Y electrodes is so large at the point of time P2, compared with the point of time P1, that a strong discharge occurs at the point of time P2. The strong discharge causes misfiring during the following sustain period.

### SUMMARY OF THE INVENTION

The present invention has been made in an effort to provide a plasma display device and its driving method having advantages of reducing a discharge delay that would be otherwise increased as an accumulative driving time of the plasma display device increases.

An exemplary embodiment of the present invention provides a method for driving a plasma display device which is driven upon dividing a single frame into multiple subfields each having a weight value. The driving method includes: accumulatively calculating a driving time of the plasma display device; comparing the calculated accumulative driving time and a pre-set first reference time; and setting the number of subfields to which a main reset waveform for initializing every discharge cell is supplied in a first frame in which the accumulative driving time is longer than the first reference time, such that it is larger than the number of subfields to which the main reset waveform is supplied in a second frame in which the accumulative driving time is shorter than the first reference time.

Another embodiment of the present invention provides a plasma display device which includes a Plasma Display Panel (PDP), a driver, and a controller, and is driven upon dividing a single frame into multiple subfields. The PDP includes a plurality of first and second electrodes and a plurality of discharge cells are formed by the plurality of first and second electrodes. The driver supplies a main reset waveform for initializing the plurality of discharge cells or an auxiliary reset waveform for initializing discharge cells that has displayed an image in an immediately previous subfield among the plurality of discharge cells to the plurality of discharge cells in the plurality of subfields. The controller accumulatively calculates the driving time of the PDP, and sets the number of subfields to which the main reset waveform is supplied in the first frame in which the calculated accumulative driving time is longer than a set first reference time, such that it is larger than the number of subfields to which the main reset waveform is supplied in the second frame in which the accumulative driving time is shorter than the first reference time.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a view of driving waveforms of a related art plasma display device.

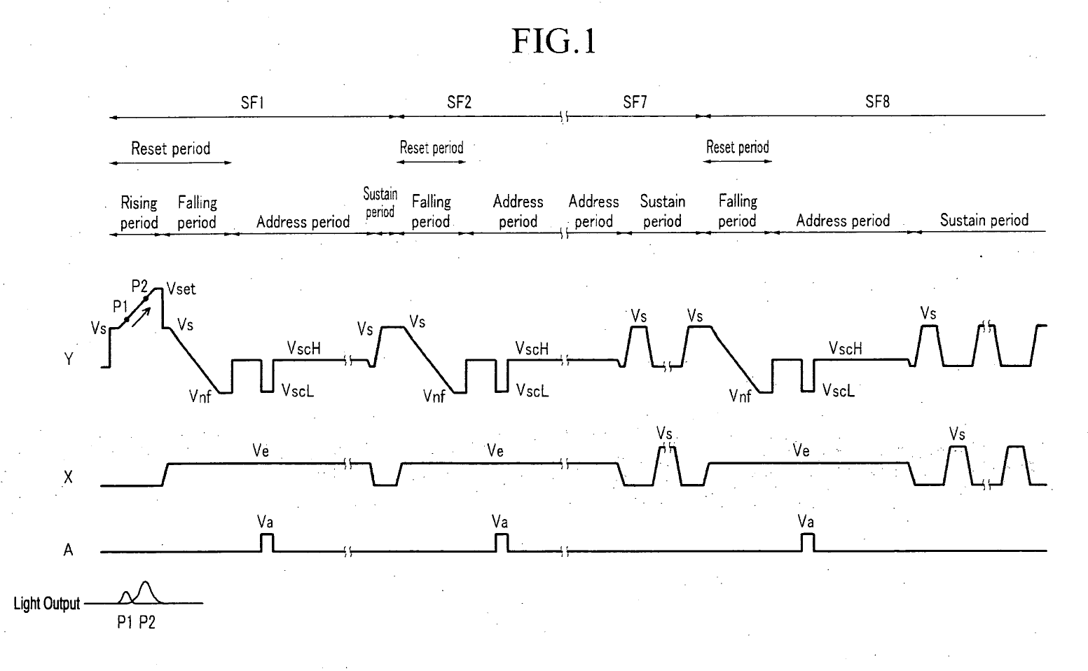

FIG. 2 is a view of a plasma display device according to an exemplary embodiment of the present invention.

FIG. 3 is a flowchart of the processes of an operation of the controller 200 of FIG. 2.

FIG. 4 is a view of a method of driving the plasma display device according to the exemplary embodiment of the present invention.

FIG. 5 is a view of the driving waveforms of the plasma display device according to the driving method in FIG. 4.

FIG. 6 is a view of a method of driving the plasma display device when a main reset is used in three subfields of a single frame according to the exemplary embodiment of the present invention.

### DETAILED DESCRIPTION OF THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification. In addition, unless explicitly described to the contrary, the word “comprise” and variations such as “comprises” or “comprising”, will be understood to imply the inclusion of stated elements but not the exclusion of any other elements.

Throughout the specification, a wall charge refers to a charge formed near each electrode on a wall (e.g., a dielectric layer) of a cell. The wall charge does not actually contact the electrodes, but in the specification, it will be described such that wall charges are formed or accumulated on the electrodes. A wall voltage refers to a potential difference formed at a wall of a cell by wall charges.

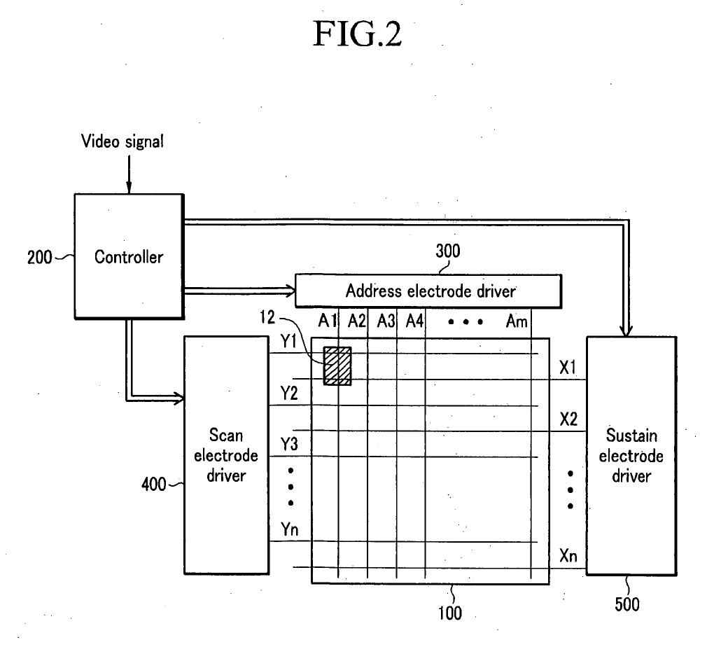

FIG. 2 is a view of a plasma display device according to an exemplary embodiment of the present invention.

As shown in FIG. 2, the plasma display device according to the exemplary embodiment of the present invention includes a Plasma Display Panel (PDP) 100, a controller 200, an address electrode driver 300, a scan electrode driver 400, and a sustain electrode driver 500.

The PDP 100 includes a plurality of address electrodes A1˜Am extending in a column direction, and a plurality of sustain electrodes X1˜Xn and scan electrodes Y1˜Yn extending in a row direction and pairing with each other. The sustain electrodes X1˜Xn are formed to correspond to the respective scan electrodes Y1˜Yn, and the sustain electrodes X1˜Xn and the scan electrodes Y1˜Yn perform an operation for displaying an image during a sustain period. The address electrodes A1˜Am are disposed to cross the sustain electrodes X1˜Xn and scan electrodes Y1˜Yn. Each discharge space present at each crossing of the address electrodes A1˜Am, the scan electrodes Y1˜Yn and the sustain electrodes X1˜Xn form cells 12. The structure of the PDP 100 is merely one example thereof, and a panel with a different structure to which a driving method described hereinbelow can be applied is also applicable in the present invention.

The controller 200 receives an external video signal and outputs an address electrode driving control signal, a sustain electrode driving control signal, and a scan electrode driving control signal. The controller 200 divides a single frame into a plurality of subfields and drives them. Each subfield includes a reset period, an address period and a sustain period in terms of temporal operations.

In the exemplary embodiment of the present invention, the controller 200 accumulatively calculates the driving time of the plasma display device, and as the accumulative driving time is lengthened, the controller 200 increases the number of subfields in which the main reset is used in a single frame. In this case, a single time or a plurality of times can be used as a reference.

The address driver 300 receives an address electrode driving control signal from the controller 200 and supplies a display data signal to each address electrode for selecting discharge cells to be displayed.

The scan electrode driver 400 receives a scan electrode driving control signal from the controller 200 and supplies a driving voltage to the scan electrodes.

The sustain electrode driver 500 receives a sustain electrode driving control signal from the controller 200 and supplies a driving voltage to the sustain electrodes.

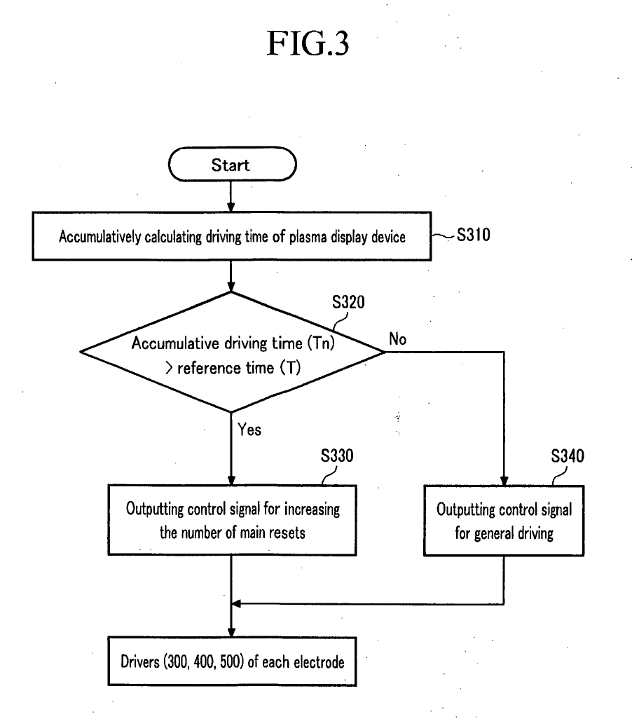

The operation of the controller of the plasma display device according to the exemplary embodiment of the present invention is described in detail below with reference to FIG. 3.

FIG. 3 is a flowchart of the processes of an operation of the controller 200 of FIG. 2.

With reference to FIG. 3, the controller 200 accumulatively calculates a driving time whenever the plasma display device is driven (S310), and compares the accumulative driving time Tn with a pre-set reference time (T) (S320).

If the accumulative driving time Tn is not smaller than the reference time (T), the controller 200 outputs a control signal for increasing the number of main resets in the plurality of subfields to drivers 300, 400, and 500 of each electrode (S330).

If, however, the accumulative driving time Tn is smaller than the reference time (T), the controller 200 outputs a control signal for supplying a general driving waveform to the drivers 300, 400, and 500 of each electrode.

The general driving waveform differs depending on the characteristics of the PDP 100. For example, if one sub-field uses the main reset in a single frame and the accumulative driving time Tn is the reference time (T) or greater, the controller 200 outputs a control signal so that the main reset can be used in at least two or more subfields in the single frame.

It is assumed in the following description that one subfield of the single frame uses the main reset in the general driving waveform. However, the present invention is not limited thereto and two or more subfields of the single frame can use the main reset.

The controller 200 may set a plurality of reference times (T), rather than one reference time (T). For example, a first reference time T1, a second reference time T2, and a third reference time T3 can be set as the reference times. As for a size of the set reference times, the first reference time T1<the second reference time T2<the third reference time T3.

When the accumulative driving time Tn is smaller than the first reference time T1, the controller 200 sets one subfield that can use the main reset in the single frame. When the accumulative driving time Tn is the first reference time T1 or greater but smaller than the second reference time T2, the controller 200 sets two subfields that can use the main reset in the single frame. When the accumulative driving time Tn is the third reference time T3 or greater, the controller 200 sets three subfields that can use the main reset. As mentioned above, the number of subfields that can use the main reset in the single frame increases one by one as the accumulative driving time Tn increases the set first to third reference time T1˜T3, respectively, but the controller 200 may output a control signal to allow two or more subfields in the single frame to use the main reset. In addition, the controller 200 may output a control signal to allow the number of subfields that can use the main reset to increase from one to three and from three to four in the single frame. As a result, the controller can control the number of subfields that can use the main reset per frame as long as the contrast of the plasma display device is not degraded.

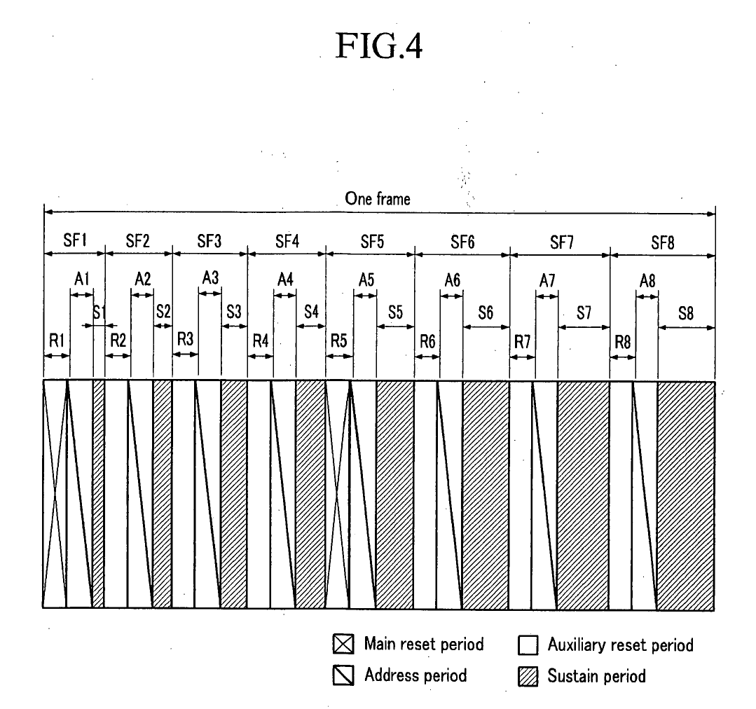

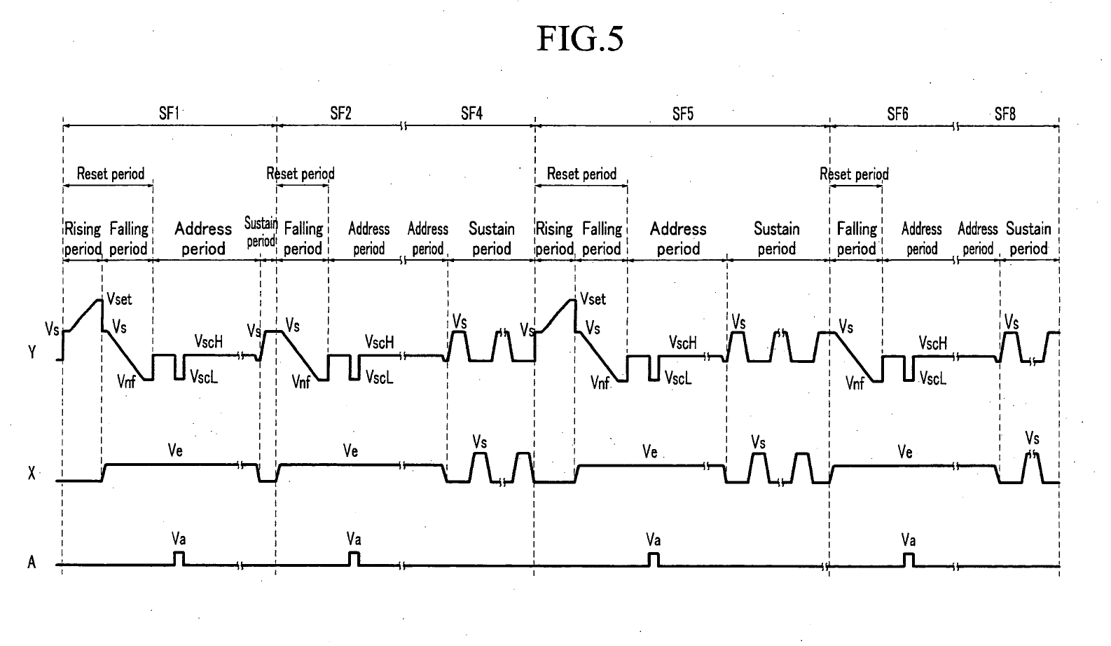

The method for driving the plasma display device according to the exemplary embodiment of the present invention is described in detail below with reference to FIGS. 4 and 5. According to the exemplary embodiment of the present invention, the single frame includes a plurality of subfields. Hereinafter, it is assumed that the single frame includes eight subfields. Hereinafter, the main reset refers to a reset period during which every discharge cell is initialized, and an auxiliary reset refers to a reset period during which a cell where a sustain discharge has occurred in an immediately previous subfield is initialized. Namely, the main reset can be defined as the reset period including a rising period and a falling period, and the auxiliary reset can be defined as the reset period including only the falling period. For the sake of convenience, driving waveforms supplied to an address electrode (referred to as an ‘A electrode’, hereinafter), a sustain electrode (referred to as an ‘X electrode’, hereinafter), and a scan electrode (referred to as a ‘Y electrode’, hereinafter) are described as follows.

FIG. 4 is a view of a method of driving the plasma display device according to the exemplary embodiment of the present invention, and FIG. 5 is a view of the driving waveforms of the plasma display device according to the driving method in FIG. 4.

As shown in FIGS. 4 and 5, in the plasma display device according to the exemplary embodiment of the present invention, when the accumulative driving time Tn is the set reference time (T) or greater, the number of subfields in the single frame that use the main reset is increased. FIGS. 4 and 5 show that, on the assumption that the main reset is driven only in the first subfield SF1 when the accumulative driving time Tn is smaller than the reference time (T), when the accumulative driving time Tn is the reference time (T) or greater, the number of subfield that uses the main reset is increased by one so the main reset is driven in two subfields. In this case, subfields for driving the main reset in the single frame are selected at uniform time intervals. Accordingly, FIGS. 4 and 5 shows that, on the assumption that the first subfield SF1 drives the main reset, an auxiliary reset of the fifth subfield is replaced by the main reset and driven.

In more detail, as shown in FIG. 5, during the rising period of the reset period of the first subfield SF1, voltages of the X and A electrodes are maintained at a reference voltage (in FIG. 5, the reference voltage is assumed to be a ground voltage (0V)) and voltage of the Y electrode is gradually increased from a voltage Vs to a voltage Vset. While the voltage of the Y electrode is increasing, a weak discharge occurs between the Y and X electrodes and Y and A electrodes, forming negative (−) wall charges on the Y electrode and positive (+) wall charges on the X and A electrodes.

During the falling period of the reset period of the first subfield SF1, in a state that the voltages of the A and X electrodes are maintained at the reference voltage and a voltage Ve, respectively, the voltage of the Y electrode is gradually decreased from the voltage Vs to a voltage Vnf. Then, a weak discharge occurs between the Y and X electrodes and the Y and A electrodes while the voltage of the Y electrode is decreasing, erasing negative (−) wall charges which have been formed on the Y electrode and the positive (+) wall charges which have been formed on the X and A electrodes. In general, the size of the voltage (Vnf-Ve) is set to be close to a discharge firing voltage Vfxy between the Y and X electrodes. Then, a wall voltage between the Y and X electrodes becomes almost 0V, so a cell in which the address discharge has not occurred during the address period can be prevented from being erroneously discharged (misfiring). When the main reset is driven during the reset period in the first subfield SF1, every discharge cell can be initialized to sufficiently form priming particles within the discharge cell 12.

During the address period of the first subfield SF1, in order to select discharge cells to be turned on, scan pulses having a voltage VscL are sequentially supplied to the plurality of Y electrodes in a state that the voltage Ve has been supplied to the X electrodes. A voltage Va is supplied to the A electrodes that pass discharge cells to be illuminated among the plurality of discharge cells formed by the Y and X electrodes to which the voltage VscL has been supplied. Then, an address discharge occurs between the A electrode to which the voltage Va has been supplied and the Y electrode to which the VscL voltage has been supplied and between the Y electrode to which the voltage VscL voltage has been supplied and the X electrode to which the voltage Ve has been supplied. Accordingly, the positive (+) wall charges are formed on the Y electrode and the negative (−) wall charges are formed on the A and X electrodes. A voltage VscH higher than the voltage VscL is supplied to a Y electrode to which the voltage VscL has not been supplied, and the reference voltage is supplied to an A electrode of a discharge cell which has not been selected.

Meanwhile, in order to perform such an operation during the address period, the scan electrode driver 400 selects Y electrodes to which the scan pulse having the voltage VscL is to be supplied, among the Y electrodes (Y1˜Yn). For example, in a single driving operation, the scan electrode driver 400 may select Y electrodes in the vertically arranged order. When a single Y electrode is selected, the address electrode driver 300 selects a discharge cell to be turned on among discharge cells formed by the corresponding Y electrode. Namely, the address electrode driver 300 selects a cell to which an address pulse of the voltage Va is selected among the A electrodes.

During the sustain period of the first subfield SF1, a sustain discharge pulse having a high level voltage (voltage Vs in FIG. 5) and a low level voltage (0V in FIG. 5) is supplied with the opposite phase to the Y and X electrodes. Then, the voltage Vs is supplied to the Y electrode and 0V is supplied to the X electrode, causing a sustain discharge between the Y and X electrodes, and accordingly, negative (−) wall charges and positive (+) wall charges are formed on the Y and X electrodes. The process of supplying the sustain discharge pulse to the Y and X electrodes is repeatedly performed a number of times corresponding to a weight value indicated by the corresponding subfield. In general, the sustain discharge pulse has a square wave having a Vs sustain interval.

When the first subfield SF1 is terminated, the second subfield SF2 is driven. In this case, the operation of the second subfield SF2 during the address period and the sustain period is the same as that of the first subfield SF1, and accordingly, only the reset period is described below.

During the falling period of the second subfield SF2, when the voltages of the A and X electrodes are respectively maintained at the reference voltage and the voltage Ve, the voltage of the Y electrode is gradually decreased from the voltage Vs to the voltage Vnf. Then, while the voltage of the Y electrode is decreasing, a weak discharge occurs between the Y and X electrodes and between Y and A electrodes, erasing the negative (−) wall charges which have been formed on the Y electrode and the positive (+) wall charges which have been formed on the X and A electrodes. In this manner, in the second subfield SF2 in which the reset period is the falling period, the reset discharge occurs only when the sustain discharge occurs in the immediately previous subfield. Namely, without the sustain discharge, no reset discharge occurs. Accordingly, when the auxiliary reset is driven during the reset period in the second subfield SF2, the priming particles are formed only at a cell where the sustain discharge has occurred in the previous subfield, and are not formed at a cell where the sustain discharge has not occurred.

The third and fourth subfields SF3 and SF4 have the same operations during the reset period, the address period and the sustain period as those of the second subfield SF2, and accordingly, detailed descriptions thereof have been omitted.

When the fourth subfield SF4 is terminated, the fifth subfield SF5 is driven. In this case, an operation of the fifth subfield SF5 during the reset period, the address period and the sustain period is the same as that of the first subfield SF1, and accordingly, a detailed description thereof has been omitted.

However, in the fifth subfield SF5, during the reset period, the main reset is driven to form the priming particles in every discharge cell 12. Considering that the more priming particles in the cell, the more the discharge delay is reduced, when the accumulative driving time Tn is greater than the reference time T, the number of subfields for driving the main reset in the single frame is increased to thus prevent the discharge delay from lengthening over the accumulative driving time Tn.

When the fifth subfield SF5 is terminated, the sixth to eighth subfields SF6 to SF8 are driven. The sixth to eighth subfields SF6 to SF8 are driven in the same manner as the second sub-field SF2, and accordingly, detailed descriptions thereof have been omitted.

In the above-described case, the two subfields in the single frame use the main reset. Hereinafter, a case where three subfields in the single frame use the main reset is described.

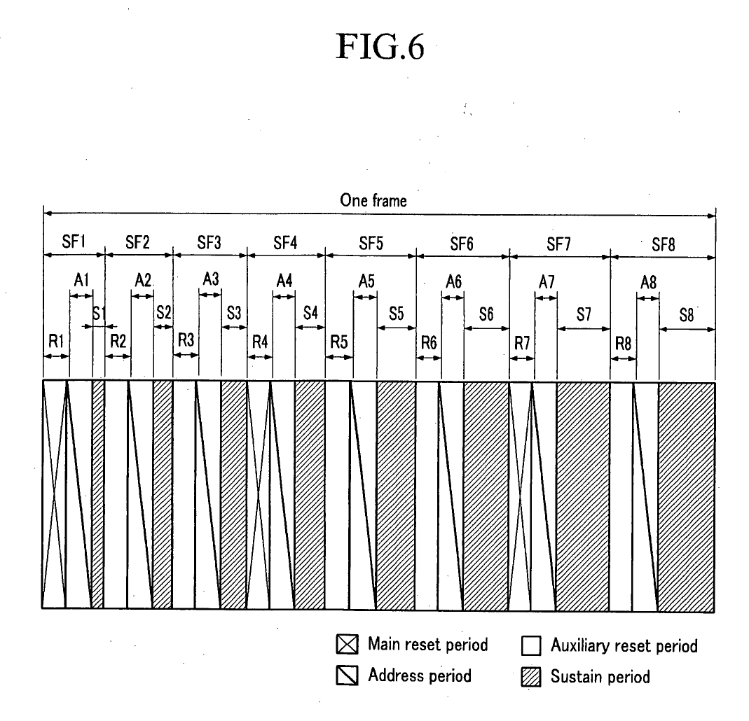

FIG. 6 is a view of a method of driving a plasma display device when the main reset is used in three subfields of the single frame according to an exemplary embodiment of the present invention.

As shown in FIG. 6, there are many cases where three subfields use the main reset period in the single frame. For one example, on the assumption that the main reset is driven only in the first subfield SF1 when the accumulative driving time Tn is smaller than the reference time (T), if the accumulative driving time Tn is the reference time (T) or greater, two subfields use the main reset. For another example, on the assumption that there are many reference times (T) and the main reset is driven only in the first sub-field SF1 when the accumulative driving time Tn is smaller than a first reference time T1, when the accumulative driving time Tn is the first reference time T1 or greater but smaller than a second reference time T2, the main reset is driven in two subfields, and when the accumulative driving time Tn is the second reference time T2 or greater, the main reset is driven in three subfields.

In this case, the subfields in which the main reset is driven are selected such that a time interval among the subfields in the single frame is similar. Accordingly, in FIG. 6, the main reset is driven in the fourth and seventh subfields SF4 and SF7 based on the first subfield SF1. In this manner, by increasing the number of subfields that use the main reset in the single frame as the accumulative driving time Tn increases, sufficient priming particles can be formed in every discharge cell. Thus, the discharge delay that may otherwise lengthen over the accumulative driving time Tn can be reduced by the priming particles.

While the present invention has been described in connection with what is presently considered to be practical exemplary embodiments, it is to be understood that the present invention is not limited to the disclosed embodiments, but, on the contrary, is intended to cover various modifications and equivalent arrangements included within the spirit and scope of the appended claims.

What is claimed is:

1. A method of driving a plasma display device which is driven upon dividing a single frame into multiple subfields each having a weight value, the method comprising:
accumulatively calculating a driving time of the plasma display device;
comparing the calculated accumulative driving time with a pre-set first reference time; and
setting the number of subfields, to which a main reset waveform for initializing every discharge cell is supplied in a first frame in which the accumulative driving time is longer than the first reference time, to be larger than the number of subfields to which the main reset waveform is supplied in a second frame in which the accumulative driving time is shorter than the first reference time.

2. The method of claim 1, further comprising:
comparing the accumulative driving time with a second reference time longer than the first reference time; and
setting the number of subfields, to which the main reset waveform is supplied in a third frame in which the accumulative driving time is longer than the second reference time, to be larger than the number of subfields to which the main reset waveform is supplied in the first frame.

3. The method of claim 2, wherein the subfields to which the main reset waveform is supplied are selected from the plurality of subfields to result in similar time intervals among the subfields in the first and third frames.

4. The method of claim 2, wherein the main reset waveform is selected to gradually increase a voltage of the first electrode from a second voltage to a third voltage in response to a first voltage being supplied to the second electrode, and to gradually reduce the voltage of the first electrode from a fifth voltage lower than the third voltage to a sixth voltage in response to a fourth voltage higher than the first voltage being supplied to the second electrode.

5. The method of claim 2, wherein an auxiliary reset waveform is supplied to a sub-field to which the main reset waveform has not been supplied in the first to third frames to initialize discharge cells which have displayed an image in an immediately previous sub-field.

6. The method of claim 2, wherein equal numbers of subfields are driven in the respective first to third frames.

7. A plasma display device driven upon dividing a single frame into multiple sub-fields, the device comprising:
a Plasma Display Panel (PDP) including a plurality of first and second electrodes and a plurality of discharge cells defined by the plurality of first and second electrodes;
a driver to supply to the plurality of discharge cells in the plurality of subfields, either a main reset waveform to initialize the plurality of discharge cells or to supply an auxiliary reset waveform to initialize discharge cells that have displayed an image in an immediately previous subfield; and
a controller to accumulatively calculate a driving time of the PDP, and to set the number of subfields, to which the main reset waveform is supplied in the first frame in which the calculated accumulative driving time is longer than a set first reference time, to be larger than the number of subfields to which the main reset waveform is supplied in the second frame in which the accumulative driving time is shorter than the first reference time.

8. The device of claim 7, wherein the controller compares a second reference time longer than the first reference time with the accumulative driving time, and sets the number of subfields to which the main reset waveform is supplied in a third frame in which the accumulative driving time is longer than the second reference time to be larger than the number of subfields to which the main reset waveform is supplied in the first frame.

9. The device of claim 8, wherein the driver supplies the main reset waveform to the subfields selected from the plurality of subfields in the first and third frames to result in similar time intervals among the subfields.

10. The device of claim 8, wherein the driver supplies the auxiliary reset waveform to a subfield to which the main reset waveform has not been supplied in the first to third frames.

11. The device of claim 8, wherein equal numbers of subfields are driven in each of the first to third frames.

12. The device of claim 7, wherein the main reset waveform supplied by the driver is selected to gradually increase a voltage of the first electrode from a second voltage to a third voltage in response to a first voltage being supplied to the second electrode, and to gradually reduce the voltage of the first electrode from a fifth voltage lower than the third voltage to a sixth voltage in response to a fourth voltage higher than the first voltage being supplied to the second electrode; and wherein the auxiliary reset waveform is supplied by the driver to a sub-field to which the main reset waveform has not been supplied in the first to third frames to initialize discharge cells which have displayed an image in an immediately previous sub-field.
